(19) United States
(12) Patent Application Publication
(10) Pub. No.: US 2009/0156764 A1
(43) Pub. Date: Jun. 18, 2009

(54) Ethylene-Based Polymers and Articles Made Therefrom

(76) Inventors: Alan M. Malakoff, Houston, TX (US); Danny Van Hoyweghen, Heverlee (BE); Nicolas Kappes, Bruxelles (BE)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/959,078

(22) Filed: Dec. 18, 2007

(51) Int. Cl. C08F 4/44; B28B 5/00

(52) U.S. Cl. 526/170; 264/239; 264/241

(57) ABSTRACT

Provided are ethylene-based polymer compositions, articles made therefrom, and methods of making the same. Ethylene-based polymer compositions include linear low density polyethylene prepared with metallocene catalyst, which may optionally have about 5 mole percent or less of monomer units derived from an alpha-olefin comonomer. Ethylene-based polymer compositions include blends of linear low density polyethylene and one or more very low density polyethylene compositions, one or more low density polyethylene compositions, one or more medium density polyethylene compositions, one or more high density polyethylene compositions, one or more differentiated polyethylene compositions, or other conventional polymers. Articles composed of such ethylene-based polymer compositions are prepared according to a process window, e.g., at a specific extrusion rates, which provides favorable physical properties, including tear resistance and dart drop properties. Films prepared according to these techniques exhibit physical properties equivalent to, or superior than, conventional linear low density polyethylenes prepared with Ziegler-Natta catalyst.

### FIELD OF THE INVENTION

The present invention is directed to ethylene-based polymers, articles made therefrom, and methods for making the same. In particular, provided are films prepared from linear low density polyethylene polymers, blends thereof, and methods of preparing the films.

### BACKGROUND OF THE INVENTION

Ethylene-based polymers are generally known in the art. For example, polymers and blends of polymers have typically been made from a linear low density polyethylene prepared using Ziegler-Natta and/or metallocene catalyst in a gas phase process.

Films made from conventional Ziegler-Natta catalyzed linear low density polyethylene (Z-N LLDPE) are known to have favorable physical properties such as stiffness and good Elmendorf tear strength. However, films prepared with metallocene catalyzed LLDPE often suffer from drawbacks such as low tear strength, in both the machine and transverse film directions, compared to films prepared with Z-N LLDPE. Thus, the film industry has sought metallocene catalyzed film resins that exhibit favorable tear properties similar to, or better than, those films resins prepared with Ziegler-Natta catalyzed resins.

The film industry is still in search of methods and compositions that overcome these shortcomings and provide improved physical properties, improved processability, and improved balance of properties.

### SUMMARY OF THE INVENTION

Provided are ethylene-based polymer compositions, articles made therefrom, and methods of making the same. Articles prepared from ethylene-based polymer compositions are prepared according to a process window, e.g., at a specific extrusion rates, which provide favorable physical properties. Articles, such as films, prepared according to these techniques exhibit physical properties equivalent to or superior than those made with conventional linear low density polyethylenes prepared with Ziegler-Natta catalyst.

Ethylene-based polymer compositions are composed of metallocene catalyzed linear low density polyethylene (LLDPE), which optionally has up to about 5 mole percent of polymer units derived from an alpha-olefin comonomer. Ethylene-based polymer compositions also include blends of linear low density polyethylene and one or more additional polymers selected form the following: one or more very low density polyethylenes, one or more low density polyethylenes, one or more medium density polyethylenes, one or more high density polyethylenes, one or more differentiated polyethylene, or other conventional polymers.

In a preferred embodiment, LLDPE is produced by polymerization of ethylene and, optionally, an alpha-olefin with a catalyst having as a transition metal component a bis(n-C₃₋₄ alkyl cyclopentadienyl)hafnium compound, wherein the transition metal component comprises from about 95 mol % to about 99 mol % of the hafnium compound. Preferably, the LLDPE polymer has up to about 5 mol % units derived from an alpha-olefin, a melt index of from about 0.1 g/10 min to about 300 g/10 min, a melt index ratio of from about 15 to about 45, a weight average molecular weight (M_{w}) of from about 20,000 to about 200,000, a molecular weight distribution (M_{w}/Mₙ) of from about 2.0 to about 4.5, and a M_{z}/M_{w} ratio of from about 1.7 to about 3.5, and a density of from about 0.900 g/cm³ to about 0.955 g/cm³.

Articles made from ethylene-based polymer compositions prepared according to a specific process window, e.g., at specific extrusion rates, provide favorable physical properties. For example, films prepared at a blown film extrusion rate of from about 10 to about 18 lbs/hr/in die circumference, exhibit increased tear resistance while maintaining excellent dart drop strength. Films prepared according to these techniques exhibit physical properties superior to those prepared from conventional linear low density polyethylenes prepared with Ziegler-Natta catalyst. Typical articles include monolayer and multilayer films, such as those prepared by blown, extruded, and/or cast stretch and/or shrink film manufacturing techniques, and articles made from such films.

### DESCRIPTION OF THE FIGURES

FIG. 1 is a graph of an ethylene-based polymer film MD Tear property as a function of extrusion rate.

FIG. 2 is a graph of an ethylene-based polymer film TD Tear property as a function of extrusion rate.

FIG. 3 is a graph of an ethylene-based polymer film Dart prop (A) property as function of extrusion rate.

FIG. 4 is a graph of an ethylene-based polymer film MD Tensile Strength property as function of extrusion rate.

FIG. 5 is a graph of an ethylene-based polymer film TD Tensile Strength property as function of extrusion rate.

FIG. 6 is a graph of the ratio of MD/TD Tensile Strength properties of an ethylene-based polymer film as function of extrusion rate.

### DETAILED DESCRIPTION OF THE INVENTION

Provided are ethylene-based polymer compositions, articles made therefrom, and methods of making the same. Articles prepared from ethylene-based polymer compositions are prepared according to a process window, e.g., at a specific extrusion rates, which provide favorable physical properties. Articles, such as films, prepared according to these techniques exhibit physical properties equivalent to or superior than those made with conventional linear low density polyethylenes prepared with Ziegler-Natta catalyst.

Ethylene-based polymer compositions are composed of metallocene catalyzed linear low density polyethylene or blends of linear low density polyethylene and one or more additional polymers. As used herein, “linear low density polyethylene” and “LLDPE” mean substantially linear polyethylene homopolymers or copolymers having a significant number of short branches. LLDPEs are distinguished structurally from conventional low-density polyethylene due to a low incidence of long chain branching. “Metallocene catalyzed linear low density polyethylene” and “mLLDPE” mean a LLDPE produced with a metallocene catalyst. As used herein “copolymer” means polymers having more than one type of monomer, including interpolymers, terpolymers, or higher order polymers. Preferably, LLDPEs have minimal long chain branching.

Conventional ethylene-based polymer compositions are described in U.S. Pat. Nos. 6,956,088, 6,936,675, 6,528,597, 6,248,845, and 6,242,545, each of which is herein incorporated by reference in its entirety. Ethylene based polymer compositions are also described in U.S. Provisional Application No. 60/809,509 and U.S. application Ser. Nos. 11/789,391, 11/135,882, and 11/098,077, each of which is herein incorporated by reference in its entirety.

LLDPE comonomers include alpha-olefin comonomers selected from those having 3 to 20 carbon atoms, such as C₃-C₂₀ alpha-olefins or C₃-C₁₂ alpha-olefins. Alpha-olefin comonomers are linear or branched or may include two unsaturated carbon-carbon bonds, i.e., dienes. Examples of suitable comonomers include linear C₃-C₁₂ alpha-olefins and alpha-olefins having one or more C₁-C₃ alkyl branches or an aryl group. Comonomer examples include propylene, 1-butene, 3-methyl-1-butene, 3,3-dimethyl-1-butene, 1-pentene, 1-pentene with one or more methyl, ethyl, or propyl substituents, 1-hexene, 1-hexene with one or more methyl, ethyl, or propyl substituents, 1-heptene, 1-heptene with one or more methyl, ethyl, or propyl substituents, 1-octene, 1-octene with one or more methyl, ethyl, or propyl substituents, 1-nonene, 1-nonene with one or more methyl, ethyl, or propyl substituents, ethyl, methyl, or dimethyl-substituted 1-decene, 1-dodecene, and styrene. Exemplary combinations of ethylene and comonomers include: ethylene 1-butene, ethylene 1-pentene, ethylene 4-methyl-1-pentene, ethylene 1-hexene, ethylene 1-octene, ethylene decene, ethylene dodecene, ethylene 1-butene 1-hexene, ethylene 1-butene 1-pentene, ethylene 1-butene 4-methyl-1-pentene, ethylene 1-butene 1-octene, ethylene 1-hexene 1-pentene, ethylene 1-hexene 4-methyl-1-pentene, ethylene 1-hexene 1-octene, ethylene 1-hexene decene, ethylene 1-hexene dodecene, ethylene propylene 1-octene, ethylene 1-octene 1-butene, ethylene 1-octene 1-pentene, ethylene 1-octene 4-methyl-1-pentene, ethylene 1-octene 1-hexene, ethylene 1-octene decene, ethylene 1-octene dodecene, and combinations thereof. It should be appreciated that the foregoing list of comonomers and comonomer combinations are merely exemplary and are not intended to be limiting. Preferably, the comonomer is 1-butene, 1-hexene, or 1-octene. Most preferably, the comonomer is 1-hexene.

If a comonomer is used, the monomer is generally polymerized in a proportion of from 50.0 to 99.9 wt % of monomer, preferably, from 70 to 99 wt % of monomer, and more preferably, from 85 to 95 wt % of monomer, with from 0.1 to 50 wt % of comonomer, preferably, from 5 to 15 wt % of comonomer, and more preferably, from 2 to 20 wt % of comonomer. For linear polyethylenes, the amount of comonomers, comonomer distribution along the polymer backbone, and comonomer branch length will generally delineate the density range.

In one or more embodiments, LLDPEs have a density in the range of from about 860 to about 970 or from about 900 g/cm³ to about 960 g/cm³. Preferably, LLDPEs have a density in the range of from about 0.900 g/cm³ to about 0.955 g/cm3, or from about 900 g/cm³ to about 0.945 g/cm³, more preferably in the range of from about 0.905 g/cm³ to about 0.940 g/cm³, more preferably in the range of from about 0.910 g/cm³ to about 0.935 g/cm³, and even more preferably in the range from about 0.915 g/cm³ to 0.925 g/cm³. Density is measured in accordance with ASTM D-1505. “Density” as used herein, and unless otherwise specified, refers to the density of the polymer independent of any additives, such as antiblocks, which may change the tested value.

In some embodiments, LLDPE has a melt index, I_{2.16}, of from about 0.1 g/10 min to about 10 g/10 min. Preferably, LLDPE has a melt index, I_{2.16}, of from about 0.3 g/10 min to about 3.0 g/10 min, or from about 0.5 g/10 min to about 1.5 g/10 min, or from about 0.8 g/10 min to about 1.2 g/10 min. In one embodiment, LLDPE has a melt index, I_{2.16}, of about 1. I_{2.16} is measured by ASTM D-1238-E (190/2.16).

In some embodiments, LLDPE has a melt index ratio (I_{21.6}/I_{2.16}) as measured by ASTM D-1238-F (190/21.6), of from about 10 to about 50 or from about 20 to about 45, or from about 20 to about 40, or from about 22 to about 38, or from about 22 to about 35.

LLDPE melt temperature may also be used to describe its usefulness in various applications. An exemplary method of identifying a composition's melting temperature is determined by first pressing a sample of the composition at elevated temperature and removing the sample with a punch die. The sample is then annealed at room temperature. After annealing, the sample is placed in a differential scanning calorimeter, e.g., Perkin Elmer 7 Series Thermal Analysis System, and cooled. Then the sample is heated to a final temperature and the thermal output, ΔH_{f}, is recorded as the area under the melting peak curve of the sample. The thermal output in joules is a measure of the heat of fusion. The melting temperature, Tₘ₁, is recorded as the temperature of the greatest heat absorption within the range of melting of the sample. This is called the first melt. The sample is then cooled. T_{c} is the non-isothermal crystallization temperature, which is recorded as the temperature of greatest heat generation. The sample is reheating to form a second melt, which is more reproducible than the first melt. The peak melting temperature from the second melt is recorded as the second melting temperature, Tₘ₂.

Preferably, LLDPE exhibits a second melt temperature of from about 100° C. to about 130° C., or about 110° C. to about 130° C., or from about 119 to about 125, or from about 119° C. to about 123° C. Preferably, LLDPE exhibit a first melt temperature, T_{c}, of from about 95 to about 125, or from about 100 to about 118, or from about 107 to about 110.

Composition distribution is measured by Composition Distribution Breadth Index (CDBI) or solubility distribution breadth index (SDBI). Further details of determining the CDBI or SDBI of a copolymer are known to those skilled in the art. See, for example, PCT Patent Application WO 93/03093, published Feb. 18, 1993, which is herein incorporated by reference in its entirety.

CDBI is the weight percent of a copolymer having a comonomer content within 50% of the median total molar comonomer content. The CDBI of a copolymer is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., Vol. 20, pg. 441 (1982) and U.S. Pat. No. 5,008,204, which are fully incorporated herein by reference. As used herein SDBI measures the breadth of the solubility distribution curve for a given polymer.

Both CDBI and SDBI may be determined using data obtained via CRYSTAF. In such cases, a commercial CRYSTAF model 200 instrument (PolymerChar S.A.) is used for chemical composition distribution (CCD) analysis. Approximately 20 to 30 mg of polymer is placed into each reactor and dissolved in 30 ml of 1,2 dichlorobenzene at 160° C. for approximately 60 minutes, then allowed to equilibrate for approximately 45 minutes at 100° C. The polymer solution is then cooled to either 30° C. (standard procedure) or 0° C. (cryo procedure) using a cooling rate of 0.2° C./min. A two wavelength infrared detector is then used to measure the polymer concentration during crystallization (3.5 μm, 2853 cm⁻¹ sym. stretch) and to compensate for base line drifts (3.6 μm) during the analysis time. The solution concentration is monitored at certain temperature intervals, yielding a cumulative concentration curve. The derivative of this curve with respect to temperature represents the weight fraction of crystallized polymer at each temperature. In both standard and cryo procedures, any resin in solution below the temperature to which the solution is cooled is defined as “% solubles.” The cryo procedure outlined above, i.e., cooling to 0° C., typically provides greater detail, especially for amorphous samples that tend to stay in solution at or around 30° C.

LLDPE may have a CDBI less than about 50%, preferably less than about 40%, and more preferably less than about 35%. In one embodiment, LLDPE also has a CDBI of greater than about 20.

LLDPE may have an SDBI greater than about 15° C., or greater than about 16° C., or greater than about 17° C., or greater than about 18° C., or greater than about 19° C., or greater than about 20° C. In one embodiment, LLDPE has an SDBI of from about 18° C. to about 22° C. In another embodiment, LLDPE has a SDBI of from about 18.7° C. to about 21.4° C.

In some embodiments, LLDPE typically has a weight average molecular weight (M_{w}) of from about 15,000 to about 250,000. Preferably, the weight average molecular weight is from about 20,000 to about 200,000, or from about 25,000 to about 150,000.

Molecular weight distribution (“MWD”) is equivalent to the expression M_{w}/Mₙ. The expression M_{w}/Mₙ is the ratio of the weight average molecular weight (M_{w}) to the number average molecular weight (Mₙ). LLDPE has a molecular weight distribution (M_{w}/Mₙ) of from about 1.5 to about 5, particularly from about 2.5 to about 4.5, preferably from about 3.0 to about 4.0.

LLDPE has a ratio of z-average molecular weight to weight average molecular weight of from about 2.2 to about 3.5. In yet another embodiment, this ratio is from about 2.5 to about 3.2 or from about 2.7 to about 3.0.

The weight average molecular weight is

$${M}_{w} = \frac{{\sum }_{i} {n}_{i} {M}_{i}^{2}}{{\sum }_{i} {n}_{i} {M}_{i}}$$

The number average molecular weight is

$${M}_{n} = \frac{{\sum }_{i} {n}_{i} {M}_{i}}{{\sum }_{i} {n}_{i}}$$

The z-average molecular weight is

$${M}_{z} = \frac{{\sum }_{i} {n}_{i} {M}_{i}^{3}}{{\sum }_{i} {n}_{i} {M}_{i}^{2}}$$

where nᵢ in the foregoing equations is the number fraction of molecules of molecular weight Mᵢ. Measurements of M_{w}, M_{z}, and Mₙ are typically determined by Gel Permeation Chromatography as disclosed in Macromolecules, Vol. 34, No. 19, pg. 6812 (2001).

LLDPE is prepared with conventional catalysts and/or catalysts systems known to those skilled in the art. Exemplary catalyst systems are found in U.S. Pat. Nos. 6,242,545, 6,248,845, and 6,956,088, and U.S. Application Publication Nos. 2005/0171283 A1 and 2005/0215716 A1, each of which is herein incorporated by reference in its entirety.

Preferably, LLDPEs are prepared with a catalyst system that includes a hafnium transition metal metallocene-type catalyst for polymerizing one or more olefins. The metallocene catalyst is represented by the formula:

Cp^{A}CpHfXₙ

wherein each X is chemically bonded to Hf, each Cp group is chemically bonded to Hf, and n is 0 or an integer from 1 to 4. Preferably, n is 1 or 2. The ligands represented by Cp^{A} and Cp^{B} may be the same or different cyclopentadienyl ligands or ligands isolobal to cyclopentadienyl, either or both of which may contain heteroatoms and either or both of which may be substituted by a group R. In one embodiment, Cp^{A} and Cp^{B} are independently selected from the group consisting of cyclopentadienyl, indenyl, tetrahydroindenyl, fluorenyl, and substituted derivatives of each.

Independently, each Cp^{A} and Cp^{B} may be unsubstituted or substituted with any one or combination of substituent groups R. Non-limiting examples of substituent groups R include hydrogen radicals, alkyls, alkenyls, alkynyls, cycloalkyls, aryls, acyls, aroyls, alkoxys, aryloxys, alkylthiols, dialkylamines, alkylamidos, alkoxycarbonyls, aryloxycarbonyls, carbomoyls, alkyl- and dialkyl-carbamoyls, acyloxys, acylaminos, aroylaminos, and combinations thereof.

Exemplary hafnocene catalyst systems used to produce LLDPEs are set forth in the description and examples of U.S. Pat. Nos. 6,936,675 and 6,528,597, both of which are fully incorporated herein by reference. The hafnocene catalyst systems used herein produce polymers having higher molecular weights in comparison to zirconocene equivalents at the same or similar polymerization conditions. Additionally, the substituted hafnocenes described herein tend to produce lower density polymer products than zirconocene equivalents at substantially the same molecular weight.

LLDPEs are polymerized in any catalytic polymerization process, including solution phase processes, gas phase processes, slurry phase processes, and combinations of such processes known to those skilled in the art. Preferably, a gas or slurry phase process is used. An exemplary process used to polymerize ethylene-based polymers, such as LLDPEs, is as described in U.S. Pat. Nos. 6,936,675 and 6,528,597, which are each incorporated herein by reference.

Persons having skill in the art will recognize that the above-described processes may be tailored to achieve desired LLDPE resins. For example, comonomer to ethylene concentration or flow rate ratios are commonly used to control resin density. Similarly, hydrogen to ethylene concentrations or flow rate ratios are commonly used to control resin molecular weight.

Additionally, the use of a process continuity aid, while not required, may be desirable in any of the foregoing processes. Such continuity aids are well known to persons of skill in the art and include, for example, metal stearates.

During copolymerization, monomer feeds are regulated to provide a ratio of ethylene to comonomer, e.g., alpha-olefin, so as to yield a polyethylene having a comonomer content, as a bulk measurement, of from about 0.1 to about 5.0 mol % comonomer. In other embodiments the comonomer content is from about 0.1 to about 4.0, or from about 0.1 to about 3.0, or from about 0.1 to about 2.0, or from about 0.5 to about 5.0, or from about 1.0 to about 5.0. The reaction temperature, monomer residence time, catalyst system component quantities, and molecular weight control agent (such as H₂) may be regulated so as to provide a desired LLDPE resins.

In one embodiment, the polymerization product is a LLDPE resin produced by polymerization of ethylene and, optionally, an alpha-olefin comonomer having from 3 to 20 carbon atoms. Preferably the alpha-olefin comonomer is hexene-1.

LLDPE produced by the processes described herein, particularly in slurry or gas phase process, contain less than 5 ppm hafnium, generally less than 2 ppm hafnium, preferably less than 1.5 ppm hafnium, more preferably less than 1 ppm hafnium. In an embodiment, LLDPE contains in the range of from about 0.01 ppm to about 2 ppm hafnium, preferably in the range of from about 0.01 ppm to about 1.5 ppm hafnium, more preferably in the range of from about 0.01 ppm to 1 or less ppm hafnium.

Ethylene-based polymer compositions include blends of LLDPE and other polymers, such as additional polymers prepared from ethylene monomers. Exemplary additional polymers are linear low density polyethylene (LLDPE), non-linear low density polyethylene (LDPE), very low density polyethylene (VLDPE), medium density polyethylene (MDPE), high density polyethylene (HDPE), differentiated polyethylene (DPE), and combinations thereof. The additional polymers contemplated in certain embodiments include ethylene homopolymers and/or ethylene-olefin copolymers. Other ethylene based polymers that are used in blending are well known to those skilled in the art. Such blending may be done either in the resin production, i.e., as a reactor blend or admixture, and/or in film production.

LDPE compositions are generally known to those skilled in the art. Various conventional LDPEs have been commercially manufactured since the 1930s. Preferably, LDPE is prepared by high pressure polymerization using free radical initiators, and typically has a density in the range of 0.915-0.935 g/cm³. LDPE is also known as “branched” or “heterogeneously branched” polyethylene because of the relatively large number of long chain branches extending from the main polymer backbone.

VLDPE compositions are known to those skilled in the art. VLDPE is a subset of LLDPE generally having a density of from about 0.890 or 0.900 g/cm³ to less than about 0.915 g/cm³. VLDPEs can be produced by a number of different processes yielding polymers with different properties. Preferably, VLDPEs are prepared with metallocene catalyst, or more preferably prepared in a gas-phase, slurry, and/or solution process with a metallocene catalyst.

Relatively higher density linear polyethylene, while often considered to be within the scope of low density polyethylene, is also sometimes referred to as “medium density polyethylene” (MDPE). MDPE are known to those skilled in the art. MDPE generally having a density of from about 0.930 to about 0.945 g/cm³. MDPE can be made in any of the above processes with each of the catalyst systems described herein and, additionally, chrome catalyst systems. Preferably, MDPEs are prepared with metallocene catalyst, or more preferably prepared in a gas-phase, slurry, and/or solution process with a metallocene catalyst.

Polyethylene having a still greater density is referred to as “high density polyethylene” (HDPE), i.e., polyethylene having a density greater than 0.945 g/cm³. HDPE is typically prepared with either Ziegler-Natta or chromium-based catalysts in slurry reactors, gas phase reactors, or solution reactors. HDPE has been manufactured commercially since the 1950s in slurry systems and is well known in the art. “Medium-high molecular weight HDPE” is hereinafter defined as HDPE having a Melt Index (MI) ranging from about 0.1 g/10 min to about 1.0 g/10 min.

Differentiated polyethylenes (“DPE”) are those polyethylene polymers composed of polar comonomers or termonomers. Typical DPEs are well known in the art and include, but are not limited to, ethylene polymers comprising ethylene n-butyl acrylate, ethylene methyl acrylate acid terpolymers, ethylene acrylic acid, ethylene methyl acrylate, zinc or sodium neutralized ethylene acid copolymers, ethylene vinyl acetate, and combinations of the foregoing.

Different LLDPEs may be blended in ethylene-based polymer compositions. For example, LLDPE blends include blends of metallocene catalyzed LLDPEs or blends of metallocene catalyzed, Ziegler-Natta catalyzed, or vanadium catalyzed LLDPEs. LLPDEs may be prepared in gas phase reactors, slurry reactors, and/or solution reactors, e.g., low pressure reactor systems. Conventional LLDPEs have been commercially manufactured since the 1950s in solution reactors, since the 1980s in gas phase reactors. Exemplary LLDPE compositions and blends are described in U.S. Provisional Application Ser. No. 60/798,382, filed May 5, 2006.

Nothing with regard to these definitions is intended to be contrary to the generic definitions of these resins that are well known in the art. It should be noted, however, that LLDPE may refer to a blend of more than one LLDPE grade/type. Similarly, HDPE may refer to a blend of more than one HDPE grade/type, LDPE may refer to a blend of more than one LDPE grade/type, etc.

Generally preferred ethylene based polymers and copolymers include those sold by ExxonMobil Chemical Company in Houston Tex., including those sold as ExxonMobil HDPE, ExxonMobil LLDPE, and ExxonMobil LDPE, and those sold under the EXACT™, EXCEED™, ESCORENE™, EXXCO™, ESCOR™, ENABLE™, NTX™, PAXON™, and OPTEMA™ tradenames.

Ethylene-based polymer compositions composed of blended polymers include at least 0.1 wt % and up to 99.9 wt % of the LLDPE, and at least 0.1 wt % and up to 99.9 wt % of one or more additional polymers, with these wt % based on the total weight of the ethylene-based polymer composition. Alternative lower limits of the LLDPE can be 5%, 10%, 20%, 30%, 40%, or 50% by weight. Alternative upper limits of the LLDPE can be 95%, 90%, 80%, 70%, 60%, and 50% by weight. Ranges from any lower limit to any upper limit are within the scope of the invention. Preferred blends include more than about 90% LLDPE, and preferably more than about 95% LLDPE. In other embodiments the blends include from 5-85%, alternatively from 10-50% or from 10-30% by weight of the LLDPE. The balance of the weight percentage is the weight of the additional polymers, e.g., different LLDPE, LDPE, VLDPE, MDPE, HDPE, DPE, and combinations thereof.

In one preferred embodiment, ethylene-based polymers include a LLDPE or copolymer produced by gas-phase polymerization of ethylene and, optionally, an alpha-olefin with a catalyst having as a transition metal component a bis(n-C₃₋₄ alkyl cyclopentadienyl) hafnium compound, wherein the transition metal component comprises from about 95 to about 99 mol % of the hafnium compound. In at least one embodiment, the LLDPE preferably has a comonomer content of up to about 5 mole %, a melt index I_{2.16} of from about 0.1 to about 300 g/10 min, a melt index ratio of from about 15 to about 45, a weight average molecular weight of from about 20,000 to about 200,000, a molecular weight distribution of from about 2.0 to about 4.5, and a M_{z}/M_{w} ratio of from about 1.7 to about 3.5. In another embodiment, LLDPE has a comonomer content of up to about 5 mol %, a melt index I_{2.16} of from about 0.1 to about 10 g/10 min, a melt index ratio of from about 20 to about 45, a weight average molecular weight of from about 20,000 to about 200,000, a molecular weight distribution of from about 2.5 to about 4.5, a M_{z}/M_{w} ratio of from about 2.2 to about 3.5, and a density a density of from about 0.900 g/cm³ to about 0.945 g/cm³ or from about 0.910 g/cm³ to about 0.935 g/cm³.

### Other Ethylene-Based Polymer Blends

In one or more embodiments, ethylene-based polymer compositions are blended with one or more other polymers or copolymers. Other polymers that may be blended with ethylene-based polymer compositions include, but are not limited to, propylene-based polymers, propylene ethylene copolymers, polymers derived from dienes, and combinations of the foregoing. For example, ethylene-based polymer compositions may be blended with one or more polymers derived from conjugated and non-conjugated dienes, such as, for example:
(a) straight chain acyclic dienes, such as 1,4-hexadiene and 1,6-octadiene,
(b) branched chain acyclic dienes, such as 5-methyl-1,4-hexadiene, 3,7-dimethyl-1,6-octadiene, and 3,7-dimethyl-1,7-octadiene,
(c) single ring alicyclic dienes, such as 1,4-cyclohexadiene, 1,5-cyclo-octadiene, tetracyclo-(δ-11,12)-5,8-dodecene, and 1,7-cyclododecadiene,
(d) multi-ring alicyclic fused and bridged ring dienes, such as tetrahydroindene, norbornadiene, methyl-tetrahydroindene, dicyclopentadiene (DCPD), bicyclo-(2,2,1)-hepta-2,5-diene, alkenyl, alkylidene, cycloalkenyl and cycloalkylidene norbornenes, such as 5-methylene-2-norbornene (MNB), 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, and 5-vinyl-2-norbornene (VNB), and
(e) cycloalkenyl-substituted alkenes, such as vinyl cyclohexene, allyl cyclohexene, vinyl cyclooctene, 4-vinyl cyclohexene, allyl cyclodecane, and vinyl cyclododecane.

Persons of ordinary skill in the art will recognize that a wide variety of polymers, copolymers, and polymer blends may be blended with ethylene-based polymer compositions. Such additional blend components, though not particularly described herein, are within the scope and intended spirit of the invention.

### Preparation of Blends

Blends are formed using conventional equipment and methods. For example, blending is accomplished by dry blending individual components and subsequently melt mixing in a mixer, or by mixing the components together directly in a mixer. Exemplary mixers include, for example, Banbury mixers, a Haake mixers, Brabender internal mixers, or a single or twin-screw extruder. Extruders used for mixing may include a compounding extruder and a side-arm extruder used directly downstream of a polymerization process.

Additionally, additives may be included in a blend, in one or more components of the blend, and/or in a product formed from the blend, such as a film, as desired. Such additives are well known in the art, and can include, for example: fillers, antioxidants (e.g., hindered phenolics such as IRGANOX™ 1010 or IRGANOX™ 1076 available from Ciba-Geigy), phosphites (e.g., IRGAFOS™ 168 available from Ciba-Geigy), anti-cling additives, tackifiers, such as polybutenes, terpene resins, aliphatic and aromatic hydrocarbon resins, alkali metal and glycerol stearates and hydrogenated rosins, UV stabilizers, heat stabilizers, anti-blocking agents, release agents, slip agents, anti-static agents, pigments, colorants, dyes, waxes, silica, fillers, and talc.

### Extrusion

Once prepared, ethylene-based polymers are extruded to melt and then formed through a die to make a useful final article, such as a film. A variety of equipment from several manufacturers can be used. Rates of production generally range up to 2000 lbs/hr depending on equipment type, size, and configuration. Ethylene-based polymers are extruded at standard or non-standard process conditions commonly used by the film manufacturing industry.

One or more extruders can be used to produce the final object. Such films are well known to those skilled in the art as monolayer or coextruded films. Multiple extruders all running the same polymer can manufacture a coextruded film that is similar in performance to a monolayer film of the same polymer. This may be done due to a restrictive equipment configuration or to obtain a desired high output rate.

Although the extruder and die sizes vary, the film industry has taken to describing manufacturing processes with normalized rates. All extrusion rates stated herein are normalized, unless specified otherwise. On equipment used to manufacture film by the ‘blown film process’, such rates are typically expressed as lbs/hr/in die circumference reflect the rate normalized to the annular blown film die size. Many process and property parameters correlate with this normalized rate. If other process variables are held constant, increasing extrusion rates will generally increase the machine direction orientation of films.

Ethylene-based polymer compositions are extruded on blown-film equipment at from at least about 1.0 lb/hr/in die. Preferably, ethylene-based polymer compositions are extruded at from about 3 to about 25 lb/hr/in die, or from about 10 lb/hr/in die to 25 lb/hr/in die, or from about 10 lb/hr/in die to about 20 lb/hr/in die. In some embodiments, ethylene-based polymer compositions are extruded at over 25 lb/hr/in die.

Contrary to the expectation of one skilled in the art that that increasing extrusion rate will decrease tear resistance, it was surprisingly found that tear resistance increased when films were extruded at a normalized rate of from about 12 lb/hr/in die circumference to about 18 lb/hr/in die circumference, or preferably at a rate of from about 14 lb/hr/in die circumference to about 17 lb/hr/in die circumference. In addition, the dart drop impact property of such films is maintained at levels equivalent to leading ethylene based polymers while tear resistance increases.

Extrusion temperature generally is determined by the ethylene-based composition being extruded. The extrusion temperature may be held at a flat temperature profile, or may vary. For example, the extrusion temperature may increase to a maximum and then decrease, i.e., a “hump profile.” Heating profiles are achieved by setting extruder zones at different temperatures. For example, zone one is set to a relatively cool temperature, zone two is set to a relatively high temperate, and then zones three and four, and five if present, are set relatively lower than zone two but still much higher than zone one.

In one or more embodiments, the extrusion temperature is from about 180 degrees Centigrade to about 220 degrees Centigrade, or from about 185 degrees Centigrade to about 215 degrees Centigrade. Preferably, the extrusion temperature is held constant at about 190 degrees Centigrade.

Film blow up ratio, i.e., BUR, is from about 2.0 to about 3.0, or from about 2.2 to about 2.8. Preferably, the film blow up ratio is 2.5.

### End-Use Applications

Any of the foregoing ethylene-based polymer compositions may be used in a variety of end-use applications, including film-based products, which include stretch/wrap films, shrink films, cling films, sealing films, oriented films, bags, e.g., shipping sacks, trash bags, liners, industrial liners, produce bags, heavy duty bags, and grocery bags, flexible and food packaging, e.g., fresh cut produce packaging, baked packaging, frozen food packaging, personal care films, pouches, medical film products, such as intravenous bags, diaper backsheets and housewrap. Products may also include packaging, for example by bundling, packaging and unitizing a variety of products. Applications for such packaging include various foodstuffs, rolls of carpet, liquid containers and various like goods normally containerized and/or palletized for shipping, storage, and/or display. Further product applications may also include surface protection applications, with or without stretching, such as in the temporary protection of surfaces during manufacturing, transportation, etc. There are many potential applications of articles and films produced from the ethylene-based polymer compositions described herein.

### Films

Ethylene-based polymer compositions may be utilized to prepare monolayer films or multilayer films. These films may be formed by any number of well known extrusion or coextrusion techniques discussed below. Films may be unoriented, uniaxially oriented or biaxially oriented. Physical properties of the film may vary depending on the film forming techniques used. In multilayer films, at least one layer of film is prepared according to a specific process window, e.g., at specific extrusion rates as described above.

Films or layers of films are prepared at a process window that provides favorable physical properties. The process window includes the rate of extrusion utilized and the process variable described herein. Process conditions other than the rate of extrusion, e.g., extrusion temperature, etc., can be any process condition commonly known to those skilled in the art. For example, exemplary methods for manufacturing films are described in U.S. Pat. Nos. 6,956,088, 6,936,675, 6,528,597, 6,248,845, and 6,242,545, U.S. Provisional Application No. 60/809,509, and U.S. application Ser. Nos. 11/789,391, 11/135,882, and 11/098,077.

Exemplary films include blown films formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications.

Multiple-layer films may be formed by methods well known in the art. The total thickness of multilayer films may vary based upon the application desired. A total film thickness of about 5-100 μm, more typically about 5-50 μm, 5-30 μm, or 10-30 μm, is suitable for most applications. Those skilled in the art will appreciate that the thickness of individual layers for multilayer films may be adjusted based on desired end-use performance, resin or copolymer employed, equipment capability, and other factors. The materials forming each layer may be coextruded through a coextrusion feedblock and die assembly to yield a film with two or more layers adhered together but differing in composition.

When used in multilayer films, the LLDPE may be used in any layer of the film, or in more than one layer of the film, as desired. When more than one layer of the film is formed of a LLDPE blend, each such layer can be individually formulated, i.e., the layers formed of the LLDPE blend can be the same or different chemical composition, density, melt index, thickness, etc., depending upon the desired properties of the film.

To facilitate discussion of different film structures, the following notation is used herein. Each layer of a film is denoted “A” or “B”, where “A” indicates a conventional film layer as defined below, and “B” indicates a film layer formed of any of the LLDPEs or blends. Where a film includes more than one A layer or more than one B layer, one or more prime symbols (′, ″, ′″, etc.) are appended to the A or B symbol to indicate layers of the same type (conventional or inventive) that can be the same or can differ in one or more properties, such as chemical composition, density, melt index, thickness, etc. Finally, the symbols for adjacent layers are separated by a slash (/). Using this notation, a three-layer film having an inner layer of a LLDPE blend disposed between two outer, conventional film layers would be denoted A/B/A′. Similarly, a five-layer film of alternating conventional/inventive layers would be denoted A/B/A′/B′/A″. Unless otherwise indicated, the left-to-right or right-to-left order of layers does not matter, nor does the order of prime symbols, e.g., an A/B film is equivalent to a B/A film, and an A/A′/B/A″ film is equivalent to an A/B/A′/A″ film. The relative thickness of each film layer is similarly denoted, with the thickness of each layer relative to a total film thickness of 100 (dimensionless) indicated numerically and separated by slashes, e.g., the relative thickness of an A/B/A′ film having A and A′ layers of 10 μm each and a B layer of 30 μm is denoted as 20/60/20.

For the various films described herein, the “A” layer can be formed of any material known in the art for use in multilayer films or in film-coated products. Thus, for example, each A layer can be formed of a polyethylene homopolymer or copolymer, and the polyethylene can be, for example, a VLDPE, a LDPE, a LLDPE, a MDPE, a HDPE, or a DPE, as well as other polyethylenes known in the art. The polyethylene can be produced by any suitable process, including metallocene-catalyzed processes and Ziegler-Natta catalyzed processes. Further, each A layer can be a blend of two or more such polyethylenes, and can include additives known in the art. Further, one skilled in the art will understand that the layers of a multilayer film should have an appropriate viscosity match.

In multilayer structures, one or more A layers can also be an adhesion-promoting tie layer, such as PRIMACOR™ ethylene-acrylic acid copolymers available from The Dow Chemical Company, and/or ethylene-vinyl acetate copolymers. Other materials for A layers can be, for example, foil, nylon, ethylene-vinyl alcohol copolymers, polyvinylidene chloride, polyethylene terephthalate, oriented polypropylene, ethylene-vinyl acetate copolymers, ethylene-acrylic acid copolymers, ethylene-methacrylic acid copolymers, graft modified polymers, and paper.

The “B” layer is formed of ethylene-based polymer composition as described herein. In one embodiment, the B layer is formed of a blend of (a) from 0.1 to 99.9 wt % of a first polymer selected from the group consisting of very low density polyethylene, medium density polyethylene, differentiated polyethylene, and combinations thereof, and (b) from 99.9 to 0.1 wt % of a second polymer comprising a LLDPE or copolymer produced by gas-phase polymerization of ethylene and, optionally, an alpha-olefin with a catalyst having as a transition metal component a bis(n-C₃₋₄ alkyl cyclopentadienyl)hafnium compound, wherein the transition metal component comprises from about 95 to about 99 mole % of the hafnium compound. The copolymer of (b) is preferably characterized by a comonomer content of up to about 5 mole %, a melt index I_{2.16} of from about 0.1 to about 300 g/10 min, a melt index ratio of from about 15 to about 45, a weight average molecular weight of from about 20,000 to about 200,000, a molecular weight distribution of from about 2.0 to about 4.5, and a M_{z}/M_{w} ratio of from about 1.7 to about 3.5. In preferred embodiments, the polymer of (a) is different from the polymer of (b).

The thickness of each layer of the film, and of the overall film, is not particularly limited, but is determined according to the desired properties of the film. Typical film layers have a thickness of from about 1 to about 1000 μm, more typically from about 5 to about 100 μm, and typical films have an overall thickness of from about 10 to about 100 μm.

In further applications, microlayer technology may be used to produce films with a large number of thinner layers. For example, microlayer technology may be used to obtain films having, for example, 24, 50, or 100 layers, in which the thickness of an individual layer is less than 1 μm. Individual layer thicknesses for these films may be less than 0.5 μm, less than 0.25 μm, or even less than 0.1 μm.

In one embodiment, ethylene-based polymer compositions may be utilized to prepare monolayer films, i.e., a film having a single layer which is a B layer as described above.

In other embodiments, using the nomenclature described above, multilayer films have any of the following exemplary structures: (a) two-layer films, such as A/B and B/B′, (b) three-layer films, such as A/B/A′, A/A′/B, B/A/B′ and B/B′/B″, (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′/B″/B′″, (d) five-layer films, such as A/A′/A″/A′″/B, A/A′/A″/B/A′″, A/A′/B/A″/A′″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B′″, B/B′/A/B″/B′″, and B/B′/B″/B′″/B″″, and similar structures for films having six, seven, eight, nine, twenty-four, forty-eight, sixty-four, one hundred, or any other number of layers. It should be appreciated that films having still more layers can be formed using the LLDPEs or blends, and such films are within the scope of the invention.

In any of the embodiments above, one or more A layers can be replaced with a substrate layer, such as glass, plastic, paper, metal, etc., or the entire film can be coated or laminated onto a substrate. Thus, although the discussion herein has focused on multilayer films, the films composed of LLDPE blends can also be used as coatings, e.g., films formed of the inventive polymers or polymer blends, or multilayer films including one or more layers formed of the inventive polymers or polymer blends, can be coated onto a substrate such as paper, metal, glass, plastic and other materials capable of accepting a coating. Such coated structures are also within the scope of the present invention.

Films can further be embossed, or produced or processed according to other known film processes. The films can be tailored to specific applications by adjusting the thickness, materials and order of the various layers, as well as the additives in or modifiers applied to each layer.

In one aspect, films containing the LLDPE, whether monolayer or multilayer, may be formed using blown techniques, i.e., to form a blown film. For example, the composition can be extruded in a molten state through an annular die and then blown and cooled to form a tubular, blown film, which can then optionally be axially slit and unfolded to form a flat film. As a specific example, blown films can be prepared as follows. The polymer or polymer blend composition is introduced into the feed hopper of an extruder, which is may have heaters, either resistance or steam and/or may have water cooling. The length of extruder to screw diameter ratio (L/D) is typically between 18:1 and 30:1. The film is extruded through the die into a film cooled by blowing air onto the surface of the film.

The film is produced through a die gap, typically between 25 mils and 120 mils. The film then flows through a dual orifice air ring, which may be rotating and/or adjustable, through which the cooling air is blown. Additional cooling may be supplied by the addition and removal of cooling air inside the bubble. Air used for cooling is typically chilled, preferably to a temperature of 50° F. to 70° F. The film is drawn from the die typically forming a cylindrical film that is cooled, collapsed and, optionally, subjected to a desired auxiliary process, such as slitting, treating, sealing, or printing. Typical melt temperatures are from about 175° C. to about 225° C.

Commercial blown film rates are generally from about 10 to over 25 lbs per hour per inch of die circumference, although laboratory and smaller lines may run at reduced rates. The finished film can be wound into rolls for later processing, or can be fed into a bag machine and converted into bags or other useful articles. A particular blown film process and apparatus suitable for forming films according to embodiments described herein are described in U.S. Pat. No. 5,569,693. Of course, other blown film forming methods can also be used and are well known to those skilled in the art.

In one embodiment, films are composed of one or more LLDPEs that exhibit a melt index ratio of from about 20 to about 40, or from about 22 to about 35, a molecular weight distribution (M_{w}/Mₙ) of from about 3.0 to about 4.0, a ratio of z-average molecular weight to weight average molecular weight of from about 2.7 to about 3.0, a density of 0.915 g/cm³ to 0.925 g/cm³, a 2^{nd} melt temperature, Tₘ₂ of from about 120 deg C. to about 125 deg C., and a CDBI of less than 50. Blown films having these characteristics are preferred. When normalized to 1 mil film thickness, films of these embodiments preferably exhibit a dart impact strength (g) of from about 200 to about 1200, an MD Elmendorf tear (g) of from about 200 to about 1000, an TD Elmendorf tear (g) of from about 400 to about 1000. More preferably these films also exhibit, a MD 1% secant modulus (kpsi) of from about 20 to about 35, a TD 1% secant modulus (kpsi) of from about 25 to about 40, a MD tensile strength (kpsi) of from about 6 to about 9 or from about 8 to about 11, and a TD tensile strength (kpsi) of from about 5 to about 8 or from about 6 to about 10.

In some embodiments, stretch cling films are formed from ethylene-based polymer compositions as described herein. The stretch cling films may be monolayer or multilayer, with one or more layers comprising a LLDPE or blend thereof. In some embodiments, the films may be coextruded, comprising one or more layers made from the LLDPEs or blends described herein, along with one or more layers of traditional Ziegler-Natta or metallocene-catalyzed LLDPE, which may, optionally, include a comonomer such as, for example, hexene or octene.

Some ethylene-based polymer compositions are also suited for use in stretch handwrap films. Stretch film handwrap requires a combination of excellent film toughness, especially puncture and dart drop performance, and a very stiff, i.e., difficult to stretch, film. This film ‘stiffness’ is required to minimize the stretch required to provide adequate load holding force to a wrapped load and to prevent further stretching of the film. The film toughness is required because handwrap loads (being wrapped) are typically more irregular and frequently contain greater puncture requirements than typical machine stretch loads. In some embodiments, the films may be downgauged stretch handwrap films. In further embodiments, LLDPE resins and blends may be blended with LDPE, other LLDPEs, or other polymers to obtain a material with characteristics suitable for use in stretch handwrap films.

Films composed of LLDPE compositions and produced under the specified conditions show improved performance and mechanical properties when compared to films previously known in the art. The films have elevated machine direction tear, similar to or better than those found in the field as well as being higher than other metallocene catalyzed polymers of similar melt index and density. The transverse direction tear also remains high and is proportional to the machine direction tear. The ratio of the tears also shows that the films have a good balance of MD and TD properties. Finally, in such films with the high tear, the dart impact strength remains elevated, comparable to the best resins currently in the market.

### EXAMPLE

The properties cited below were determined in accordance with the following test procedures. Where any of these properties is referenced in the appended claims, it is to be measured in accordance with the specified test procedure.

Where applicable, the properties and descriptions below are intended to encompass measurements in both the machine and transverse directions. Such measurements are reported separately, with the designation “MD” indicating a measurement in the machine direction, and “TD” indicating a measurement in the transverse direction.

Gauge, reported in mils, was measured using a Measuretech Series 200 instrument. The instrument measures film thickness using a capacitance gauge. For each film sample, ten film thickness datapoints were measured per inch of film as the film was passed through the gauge in a transverse direction. From these measurements, an average gauge measurement was determined and reported.

Elmendorf Tear, reported in grams (g) and/or grams per mil (g/mil), was measured as specified by ASTM D-1922.

Tensile Strength at Yield, reported in pounds per square inch (lb/in² or psi), was measured as specified by ASTM D-882.

Ultimate Tensile Strength, reported in pounds per square inch (lb/in² or psi), was measured as specified by ASTM D-882.

Elongation at Break, reported as a percentage (%), was measured as specified by ASTM D-882.

Dart F₅₀, or Dart prop Impact or Dart prop Impact Strength, reported in grams (g) and/or grams per mil (g/mil), was measured as specified by ASTM D-1709, method A.

### Example 1

An ethylene-based polymer composition composed of LLDPE was prepared to determine the effect of extrusion rate on the physical properties of films. The LLDPE composition was prepared using a bis(n-C₃₋₄ alkyl cyclopentadienyl)hafnium metallocene catalyst in a Unipol gas phase reactor provided by Univation Technologies in Seadrift, Tex. An exemplary gas phase reactor is described in the examples set forth in U.S. Pat. No. 6,956,088 B2, which is fully incorporated herein by reference.

A resin was prepared having the following density and melt index measurements:

TABLE 1

| Sample | Granular | Pellets |
|---|---|---|
| Melt Index (I_{2.16}), dg/min | 0.79 | 0.58 |
| Flow Index (I_{21.6}), dg/min | 30.15 | 20.26 |
| MIR (I_{21.6}/I_{2.16}) | 38.2 | 34.9 |
| Density (ASTM plaque), g/cm³ | 0.9190 | 0.9193 |

In Table 1, the column labeled “Granular” provides physical properties for material from the gas-phase reactor. The column labeled “Pellets” provides physical properties for the material after having been extruded.

A hindered phenolic stabilizer, BHT, was added to the granular sample for the testing of the melt and flow index. As part of the compounding operation, the pelleted sample already contained stabilizer.

The LLDPE composition was compounded with antioxidants and process aids on a ZSK-57, a 57 mm Werner & Pfleiderer twin screw extruder to yield the following concentrations:

TABLE 2

| Additive | ppm |
|---|---|
| Primary Antioxidant: | 500 |
| Irganox 1076 | |
| Secondary Antioxidant: | 2000 |
| Irgafos 168 | |
| Dynamar 5920A | 800 |

The LLDPE composition was extruded into films on a Windmoller & Holscher (W&H) line, a three extruder, three layer machine commercially available from W&H. The three extruders used were 60, 90, and 60 mm in diameter, all with a L/D of 30:1. The LLDPE composition was simultaneously run pure on each of the three extruders, at similar conditions, and into each of the three layers, forming a single coextruded film. The resulting film was a pseudo-monolayer film, i.e., a film that behaved like a monolayer film despite being made with multiple layers. Nominal extruder conditions are provided in Table 3:

TABLE 3

| | |
|---|---|
| Layer Ratio | 1/2/1 |
| Die Diameter | 250 mm |
| Die gap | 2.2 mm |
| | (starts at 1.2, widens to 2.2 at outlet) |
| Target Film Thickness | 22 microns |
| Blow Up Ratio (BUR) | 2.5 |
| Extruder Temperature Profile | Flat at 190° C. |
| Frost Line Height (FLH) | Maintain constant through run |

The starting extrusion rate was low and then stepped up to a high rate that was only limited by the test equipment. The manufacturing run was started at 160 kg/hr and then stepped up to 200, 240, and 260 kg/hr, which was the limit for the test equipment. After reaching a test limit maximum, the rate was then dropped and a sample obtained at 120 kg/hr. Although the extrusion rate was limited by the test equipment, the methods contemplated herein provide for use of higher extrusion rates as needed.

The frost line height of the three low rate runs was 80 cm. The FLH increased to 90 and 100 cm for the higher rate runs. Those skilled in the art will recognize that FLH will tend to increase with increasing production rate and the resulting increased cooling load. Those skilled in the art will also recognize that FLH is manually observed and measured, as well as it's being a variable parameter.

Table 4 summarizes the properties of the films. Test methods are as noted above, all being ASTM methods except for the gauge measurement.

TABLE 4

| Extrusion Rate, kg/hr | | 120 | 160 | 200 | 240 | 260 |
|---|---|---|---|---|---|---|
| Normalized Rate, lb/hr/in die | | 8.56 | 11.41 | 14.26 | 17.11 | 18.54 |
| circumference | | | | | | |
| Gauge, mils | | | | | | |
| Avg | | 0.79 | 0.87 | 0.90 | 0.90 | 0.83 |
| Min | | 0.69 | 0.79 | 0.84 | 0.83 | 0.76 |
| Max | | 0.88 | 0.94 | 0.95 | 0.96 | 0.97 |
| Tensile @ Yield, psi | D882 | | | | | |
| MD | | 1,449 | 1,478 | 1,449 | 1,433 | 1,363 |
| TD | | 1,634 | 1,673 | 1,597 | 1,542 | 1,518 |
| Ultimate Tensile, psi | D882 | | | | | |
| MD | | 9,983 | 10,371 | 10,679 | 10,753 | 10,136 |
| TD | | 8,885 | 7,964 | 7,563 | 8,538 | 8,893 |
| Break Elongation, % | D882 | | | | | |
| MD | | 374 | 347 | 315 | 317 | 346 |
| TD | | 670 | 661 | 674 | 659 | 637 |
| Elmendorf Tear | D1922 | | | | | |
| MD, g | | 331 | 364 | 602 | 533 | 292 |
| MD, g/mil | | 392 | 411 | 660 | 611 | 335 |
| TD, g | | 347 | 460 | 506 | 447 | 380 |
| TD, g/mil | | 434 | 499 | 557 | 507 | 433 |
| Dart Drop, g | D1709A | 609 | 598 | 508 | 623 | 661 |
| g/mil | | 771 | 687 | 564 | 692 | 796 |

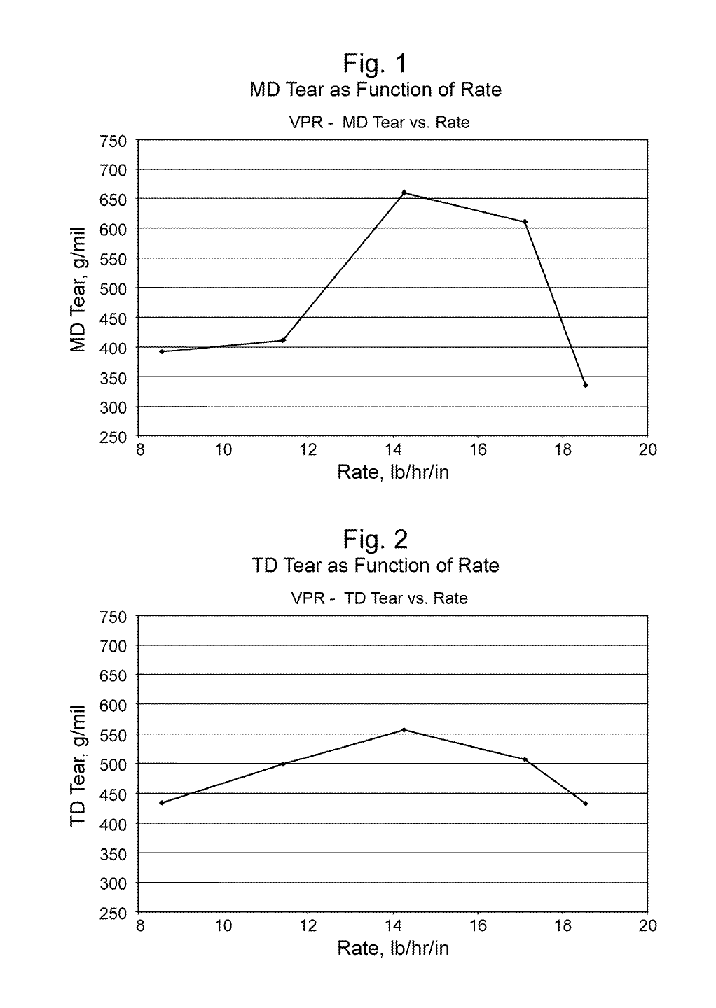

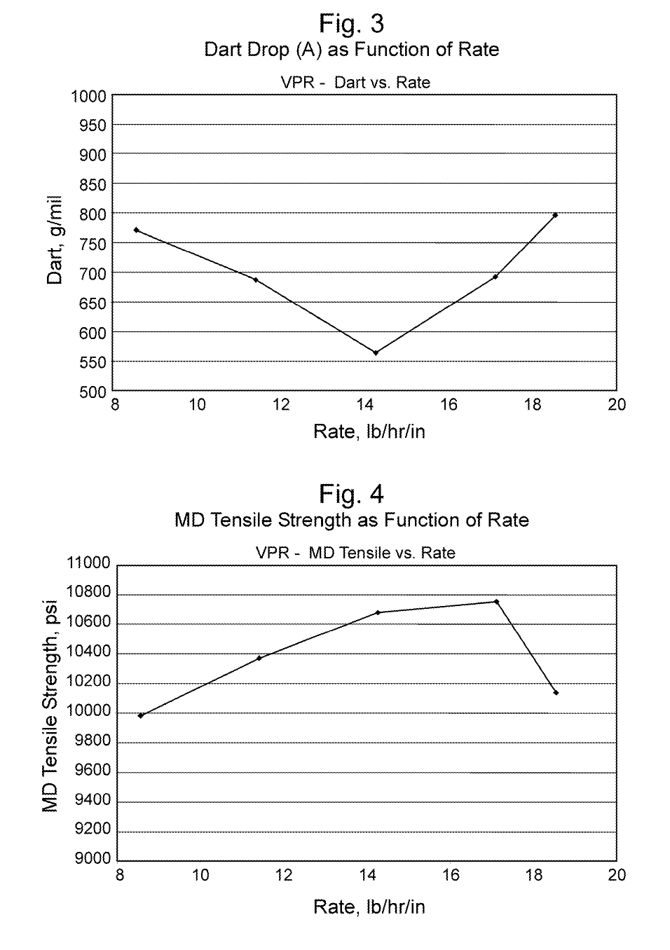

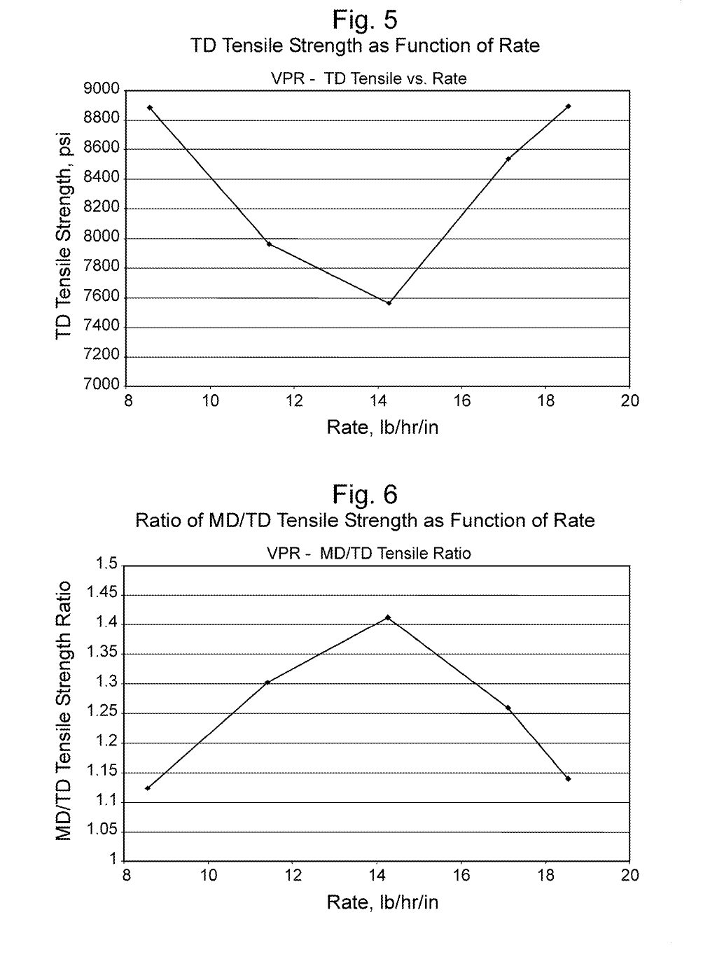

The results of table 4 are shown graphically in FIGS. 1-5 and referenced in FIG. 6, which plots the ratio of the MD and TD tensile strength.

As shown above and clearly seen graphically, as extrusion rate increases, the MD tear improves up to about 14+ lb/hr/in die. The increase in MD tear first plateaus and then declines. Dart prop properties generally decline as MD tear increases. TD tear properties tracked MD tear properties, although the magnitude of change is less. Thus an increased MD tear, as well as TD tear, can be obtained by operation of the line at specified extrusion rates, e.g., 14 lb/hr/in die to 17 lb/hr/in die range.

Although the present invention has been described in considerable detail with reference to certain aspects and embodiments thereof, other aspects and embodiments are possible. Therefore, the spirit and scope of the appended claims should not be limited to the description of the embodiments contained herein.

Certain features of the present invention are described in terms of a set of numerical upper limits and a set of numerical lower limits. It should be appreciated that ranges from any lower limit to any upper limit are within the scope of the invention unless otherwise indicated.

All patents, test procedures, and other documents cited in this application are fully incorporated herein by reference.

What is claimed is:

1. A method of preparing an extruded article comprising:
a. providing an ethylene-based polymer composition comprising a LLDPE prepared with a metallocene catalyst,
b. extruding the ethylene-based polymer composition at a rate of from about 10 to about 18 lbs/hr/in die circumference,
wherein the LLDPE has:
i. a melt index (I₂) of from about 0.1 g/10 min to about 10 g/10 min,
ii. a melt index ratio (I_{21.6}/I_{2.16}) of from about 15 to about 45,
iii. a weight average molecular weight (M_{w}) of from about 20,000 to about 200,000,
iv. a molecular weight distribution (M_{w}/Mₙ) of from about 2.0 to about 4.5, and
v. a M_{z}/M_{w} ratio of from about 1.7 to about 3.5.

2. The method of preparing an extruded article of claim 1, wherein the metallocene catalyst includes hafnium.

3. The method of preparing an extruded article of claim 1, wherein the ethylene-based polymer composition is produced by gas-phase polymerization of ethylene with a catalyst having as a transition metal component a bis(n-C₃₋₄ alkyl cyclopentadienyl)hafnium compound, and said transition metal component comprises from about 95 mol % to about 99 mol % of said hafnium compound.

4. The method of preparing an extruded article of claim 1, wherein the ethylene-based polymer composition is extruded at a rate of from about 12 to about 18 lbs/hr/in die circumference, and the LLDPE has:
i. a melt index (I₂) of from about 0.1 g/10 min to about 10 g/10 min,
ii. a melt index ratio (I_{21.6}/I_{2.16}) of from about 20 to about 45,
iii. a weight average molecular weight (M_{w}) of from about 20,000 to about 200,000,
iv. a molecular weight distribution (M_{w}/Mₙ) of from about 2.5 to about 4.5, and
v. a M_{z}/M_{w} ratio of from about 2.2 to about 3.5.

5. The method of preparing an extruded article of claim 1, further comprising the step of producing a film with a MD Elmendorf Tear of about 500 g/mil or greater as measured by ASTM D-1922.

6. The method of preparing an extruded article of claim 5, wherein the film has a Dart prop Impact (F₅₀) of from about 550 to about 800 g/mil as measured by ASTM D-1709, Procedure A.

7. The method of preparing an extruded article of claim 1, wherein the film has a TD Elmendorf Tear in excess of 400 g/mil as measured by ASTM D-1922.

8. The method of preparing an extruded article of claim 1, wherein the article is a monolayer film.

9. The method of preparing an extruded article of claim 5, wherein the film is multilayered and comprises an interior layer, and at least one additional layer that is an exterior layer, wherein the interior layer comprises the ethylene-based polymer, and the exterior layer comprises a different metallocene-catalyzed LLDPE, a Ziegler-Natta-catalyzed LLDPE, a LDPE, or combinations thereof.

10. The method of preparing an extruded article of claim 5, wherein the multilayered film consists of an interior layer and at least one additional layer that is an exterior layer, wherein both the interior layer and the exterior layer comprise the ethylene-based polymer composition.

11. The method of preparing an extruded article of claim 1, wherein the ethylene-based polymer comprises about 5 mol % or less of units derived from an alpha-olefin comonomer.

12. The method of preparing an extruded article of claim 11, wherein the ethylene-based polymer comprises about 5 mol % or less of units derived from 1-hexene.

13. The method of preparing an extruded article of claim 1, wherein the ethylene-based polymer composition further comprises:
from about 1 to about 20 wt % of a second polymer selected from the group consisting of high density polyethylene, linear low density polyethylene, low density polyethylene, medium density polyethylene, very low density polyethylene, differentiated polyethylene, and combinations thereof, based on the weight of the ethylene-based polymer composition, wherein said second polymer is different from the LLDPE.

14. The method of preparing an extruded article of claim 5, wherein the film exhibits a higher MD Elmendorf Tear compared to the same article made from a Ziegler-Natta catalyzed resin of substantially similar melt index and density.

15. The method of preparing an extruded article of claim 5, wherein the film exhibits a higher Dart prop compared to the same article made from a Ziegler-Natta catalyzed resin of substantially similar melt index and density.

16. The method of preparing an extruded article of claim 2, wherein the film exhibits a higher MD Elmendorf Tear compared to the same article made from a non-hafnium based metallocene catalyzed resin of substantially similar melt index and density.

17. The method of preparing an extruded article of claim 1, wherein the temperature of a substantial portion of the ethylene-based polymer while being extruded is from about 175° C. to about 225° C.

18. The method of preparing an extruded article of claim 1, wherein the temperature of a substantial portion of the ethylene-based polymer while being extruded is from about 180° C. to about 200° C.

19. The method of preparing an extruded article of claim 1, wherein the film has a gauge thickness of from about 1 micron to about 50 microns.

20. The method of preparing an extruded article of claim 1, wherein the extruded article comprises at least one non-polyethylene based polymer.

21. A polyethylene film comprising:
an ethylene-based polymer composition comprising a LLDPE prepared with a metallocene catalyst, having:
a. a melt index of from about 0.1 g/10 min to about 10 g/10 min,
b. a melt index ratio of from about 20 to about 45,
c. a weight average molecular weight (M_{w}) of from about 20,000 to about 200,000,
d. a molecular weight distribution (M_{w}/Mₙ) of from about 2.5 to about 4.5, and
e. a M_{z}/M_{w} ratio of from about 2.2 to about 3.5, and
f. an MD Elmendorf Tear of from about 500 to about 750 g/mil as measured by ASTM D-1922,
wherein the polyethylene film is extruded at a rate of from about 12 to about 18 lbs/hr/in die.

22. The polyethylene film of claim 21, wherein the LLDPE is prepared with a hafnium based metallocene.

23. The polyethylene film of claim 21, wherein the LLDPE comprises about 5 mole % or less of polymer units derived from 1-hexene.

24. The polyethylene film of claim 21, wherein the ethylene-based polymer comprises:
a. a first LLDPE, and
b. from about 1 to about 10 wt % of at least one additional polymer selected from the group consisting of high density polyethylene, a second linear low density polyethylene, low density polyethylene, medium density polyethylene, very low density polyethylene, differentiated polyethylene, and combinations thereof.

25. The polyethylene film of claim 21, wherein the film comprises at least one non-polyethylene based polymer.
